(19) United States
(12) Patent Application Publication
(10) Pub. No.: US 2003/0088324 A1
(43) Pub. Date: May 8, 2003

(54) Method for monitoring and controlling noise conditions

(75) Inventor: Jan Hamelink, Assenede (BE)

Correspondence Address: MICHAELSON AND WALLACE, PARKWAY 109 OFFICE CENTER, 328 NEWMAN SPRINGS RD, P O BOX 8489, RED BANK, NJ, 07701

(73) Assignee: Ergotec B.V.

(21) Appl. No.: 10/271,316

(22) Filed: Oct. 15, 2002

Related U.S. Application Data
(60) Provisional application No. 60/329,344, filed on Oct. 15, 2001.

(51) Int. Cl. G06F 17/00

(52) U.S. Cl. 700/90; 707/104.1

(57) ABSTRACT

Method for monitoring, evaluating and improving the conditions for employees of a business with a noisy environment. The method comprises creating records in a computer database, the records representing employees. Information is stored relating to a job function of a respective employee; an experienced noise level on the respective job floor of said employee; a measured effectiveness of hearing protectors worn by said employee; a measured hearing capacity of said employee. A list of employees is provided in need of improved hearing protection having an experienced noise level that is higher than a pre-selected value or wearing a hearing protector with an effectiveness that is lower than a pre-selected value. A list of employees is provided having a hearing capacity that is less than a pre-selected value and an overview is provided of measured noise levels and hearing capacities of screened employees.

### FIELD OF THE INVENTION

The invention relates to a method for monitoring and controlling noise conditions on the job floor. More specifically, the invention provides a method for monitoring, evaluating and improving the conditions for employees working in a noisy environment, such that improved hearing conservation for these people can be achieved and occupational hearing loss can be prevented.

### BACKGROUND OF THE INVENTION

In noisy environments, when engineering and administrative controls fail to reduce a noise exposure level under a safety limit, personal hearing protectors (PHP's) are to be used. Although large amounts of money are being spent on PHP's, occupational hearing loss is still one of the most common occupational diseases, with a growing number of persons suffering from reduced hearing, at even younger ages. A number of reasons can be accounted for this, among these is even the fact that people are increasingly subjected to high noise levels in their leisure time. Further, although increasingly sophisticated hearing protectors are available, usually, these devices are not used consistently, so people are not as well protected as they could be. Next, although PHP's can be sufficient to prevent people from high noise levels, the drawbacks of their use are often reasons for not wearing them. These drawbacks include a reduced sensitivity to important signals, such as warning signals or speech. Some people feel seriously constrained when wearing these protectors and unable to fully react to warnings and communicate with colleagues. Hence, those individuals choose not to wear them and, by doing so, risk early deafness.

Also, management, and the work moral in general, usually lacks awareness, or at least ignores long term consequences of not having sufficient hearing protection. So, even though in general, people know that they should wear protectors, they do not care to do so, and are not encouraged, let alone incited to wear them. Even if, incidentally, employees on the work floor are instructed to use PHP's or provided with new PHP's, this usually has very little effect, because a long term strategy is absent.

### SUMMARY OF THE INVENTION

The present invention, as one of its objects, aims to minimize a likelihood that people will acquire occupational hearing loss.

The present invention, as another object, aims to provide a total approach to monitoring, evaluating and improving the conditions for employees working in a noisy environment.

It is also an object of the invention to develop a long term strategy for reducing health hazards, in particular the hazard of acquiring occupational hearing loss, wherein management, a workforce and a supplier of hearing protectors are all involved.

In accordance with the invention, these objects are achieved by a number of specific steps which are combined with computer-based guidance and support.

The invention accordingly relates to a method for monitoring, evaluating and improving the conditions for employees of a business with a noisy environment comprising:

a) creating records in a computer database, the records representing employees, and receiving and storing in said respective records of said database the information of:

i) a job function of a respective employee;

ii) an experienced noise level on the respective job floor of said employee;

iii) a measured effectiveness of hearing protectors worn by said employee;

iv) a measured hearing capacity of said employee;

b) providing a list of employees in need of improved hearing protection having an experienced noise level that is higher than a pre-selected value or wearing a hearing protector with an effectiveness that is lower than a pre-selected value;

c) providing a list of employees having a hearing capacity that is less than a pre-selected value; and

d) providing an overview of measured noise levels and hearing capacities of screened employees.

The method according to the invention offers a concerted and multidisciplinary approach, wherein the success of a hearing conservation program is proportional to the level of communication, coordination and data-exchange between several disciplines (medical dept., safety dept., purchase dept., etc. . . . ) and other parties concerned (workforce, corporate management, suppliers of PHP'S, etc. . . . ). Further, the method according to the invention offers a systematic approach and long term policy wherein the efforts to prevent hearing damage are consistent and part of an overall long term policy. At regular intervals key-parameters (noise exposure level, hearing capacity, functionality of the PHP, commitment, etc. . . . ) are, according to the method of the invention, re-assessed and re-evaluated. Based on the outcome and when required, preventive/corrective measures can instantly be carried out. Also, the method of the invention offers an individual approach, based on the assessment of each person at risk, a ‘tailor made’ solution has to be worked out, accounting for his specific needs and wants. A computer-based centralized record keeping and management system is offered that records repeated specific activities (checks) on an individual and regular basis. The computer-based system provides guidance, support and overviews.

In particular, this system offers a special advantage in case of litigation. For this reason a database for storing records can organized such a way that: per company and/or person complete overviews can be produced on the activities performed, the results, etc. . . . and a historical track record per company/person can systematically be build up.

The method according to the invention is also referred to as a Hearing Conservation Policy (HCP). The HCP-database system can be used as a management tool, providing detection results and analysis thereof of noise conditions on the job floor, both on an individual level, as well as on a group level. When noise levels are excessive for certain individuals or functions, this can be assessed. Also, the effectiveness of the PHPs used can be monitored, for example the wearing frequency, attenuation, leaktightness and experienced comfort. In this way, the efficiency and effectiveness of noise control can be assessed; as well as the use of PHP's and the condition of the hearing faculties of the employees on the job floor. By controlling the efficiency and effectiveness, a number of inadequacies of the use of PHP's can be prevented, as there are: a lack of fitting comfort and user compliance or an attenuation of the PHP that can not be adjusted in relation to the individual noise exposure level. These inadequacies can lead to a situation of ‘insufficient protection’, resulting in a false feeling of being secured against the noise or ‘overprotection’ leading to a reduced sensitivity to important signals. Further, a lack of proof on the product liability when being worn (in situ) can be prevented. The liability of a PHP ‘in situ’ depends on the leak tight fit (100% seal). If a PHP does not seal the ear canal, the noise bypasses the PHP, resulting in a dramatic drop of the level of attenuation (functionality).

Because of the systematic and total approach of HCP, it can be avoided that certain individuals or groups are left out from the program. Therefor, with the use of HCP, it can be determined for all workers on the job floor, whether incomplete or insufficient protection is existent, and such incomplete protection can be addressed. In this way ongoing overexposure to noise will be substantially reduced and occupational deafness will be greatly minimized. Further, if an incomplete protection is found present, other causes than noise at work may have to be considered, such as diseases, exposure to high noise levels during leisure time etc.

In a preferred embodiment, the method comprises the step of receiving and storing in a respective database record a code identifying the possibility for said employee to wear hearing protectors in view of hazards with respect to warning signals or speech-intelligibility. Through an initial measurement it is determined whether hazards to hearing, speech-intelligibility or recognition of warning signals exist. This can be the case, when workers are dependent on their hearing faculties for interpreting hazardous situations, for instance, because no other signals, such as visual signals are present to indicate an existing hazard. By such an initial measurement, a baseline can be established in order to evaluate collective noise control efforts (such as engineering and administrative controls) and individual noise control efforts (such as PHP's). Then, a necessary base-attenuation level to be provided by PHP's can be determined, as well as which employees on the job floor need to be included in the HCP. A repeated measurement of the noise level may result in the evaluation of noise control efforts, the readjustment of attenuation levels of PHP's in use, and in the construction of an overview in time of the noise exposure of employees.

Further, the step of receiving and storing information regarding a measured noise level preferably comprises a read out from a detection unit which can be coupled directly to the computer. The computer thus conveniently co-operates with a detection unit, which outputs detected noise levels which can be entered directly into the computer for further storing and processing. A preferred detection method is measuring the noise energy over time for a specific person or group of persons. In this way a time-averaged value can be obtained, which offers more reliable results. In a preferred embodiment the method comprises measuring a persons individual noise energy over time using dose-badges. In this way, a persons noise-dose (time-averaged value) is obtained, which offers more reliable results as to simply measuring the noise energy at a specific place and time. In a further preferred embodiment, the method according to the invention is applied with hearing protectors that are custom molded. The attenuation level of such hearing protectors can be set according to a personal noise exposure level. Such a personal approach can lead to a better adjustment to individual needs of each employee, at the same time optimizing the wearing comfort and the wearing frequency, thereby improving the effectiveness of the PHP. Also, these personal hearing protectors offer a possibility to be checked on leaktight fit when in situ (efficiency of the PHP). By such personal hearing protectors, an employee is optimally protected against noise while preserving intelligibility to speech and recognition of warning signals. As part of the invention each PHP entering the system is (to be) equipped with a unique serial number and preferably a tunable attenuation valve.

Furthermore, in the inventive method, the screening of a hearing capacity is preferably performed by applying an Oto Acoustic Emission (OAE), such measurement resulting in a PASS or a REFER outcome. In case of a REFER criterion, the employee is referred for further testing to a medical department. An initial audiometric screening determines a baseline of the hearing capacity of each employee entering the HCP. A follow up screening monitors the efficiency and effectiveness of the HCP by comparing the outcome of such screening to a baseline screening, thus building up an overview in time of the hearing capacity of employees.

Preferably, according to the invention, providing said overview comprises relating measured noise levels and hearing capacities to an averaged value of functionally related employees or function groups in the database. In this way, a comparison can be made which places the results of a company served by the HCP program in perspective. Thus, if a specific company in the HCP-program scores substantially higher in detected noise levels or hearing disability, this might be an indication that further administrative and/or technical measures have to be taken.

The invention also relates to a computer comprising:

a) storing means for storing entities comprising information of:

i) an employee;

ii) a job function of said employee;

iii) an experienced noise level on the respective job floor of said employee;

iv) a measured effectiveness of hearing protectors worn by said employee;

v) a measured hearing capacity of said employee;

b) input means for inputting said information in said storing means

c) processing means coupled to said storing means for determining entities with an experienced noise level that is higher than a pre-selected value or wearing a hearing protector with an effectiveness that is lower than a pre-selected value and for determining entities with a hearing capacity that is less than a pre-selected value;

d) processing means coupled to said storing means for determining an averaged value of measured noise levels and hearing capacities of a selected group of entities

e) output means for conveying a list of employees in need of improved hearing protection, for conveying a list of employees having a reduced hearing capacity and for providing an overview of measured noise levels and hearing capacities of screened employees, determined by the processing means.

The computer preferably comprises coupling means for inputting a detected noise level of a noise level detection unit or for coupling to a central computer storing a history of inputted entities of the database.

The invention also relates to a computer program product that is machine readable to a computer for monitoring, evaluating and improving the conditions for employees of a business with a noisy environment, wherein, after the computer program product is read, the computer is configured according at least one of the preceding aspects Also, the invention relates to an information carrier comprising a computer program product according to at least one of the preceding aspects.

### BRIEF DESCRIPTION OF THE DRAWINGS

The invention will further be elucidated with reference to the drawing, illustrating an example of a practical embodiment of a method according to the invention.

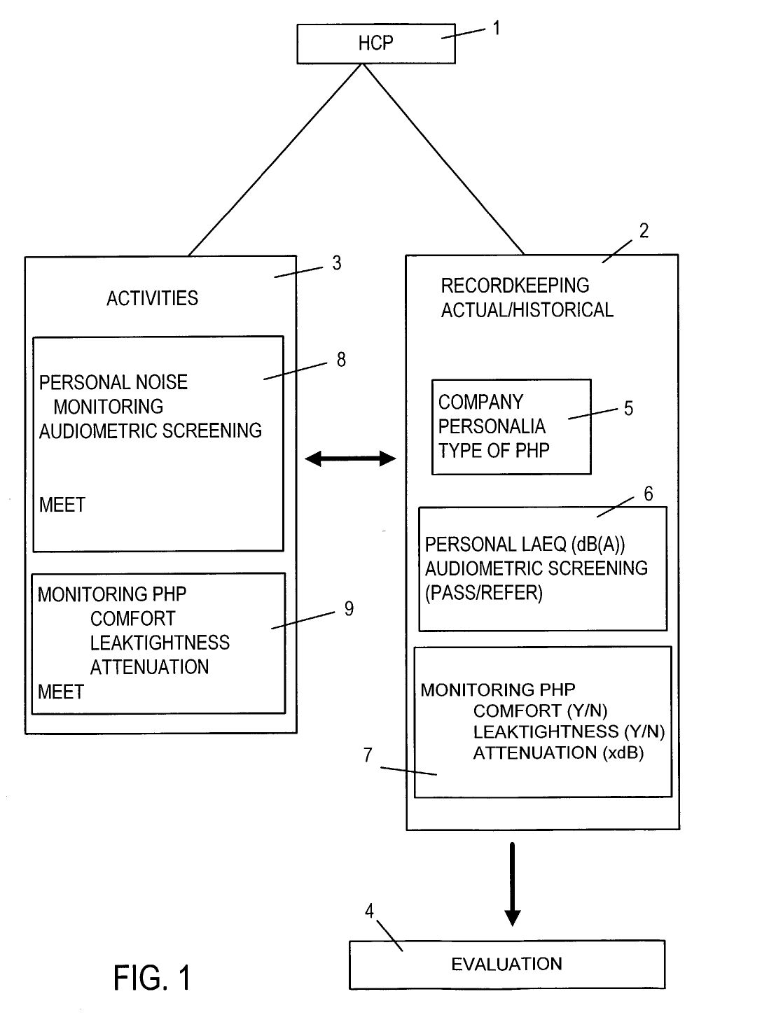

In the drawing, in FIG. 1, a schematic overview is given from the components of the system according to the invention;

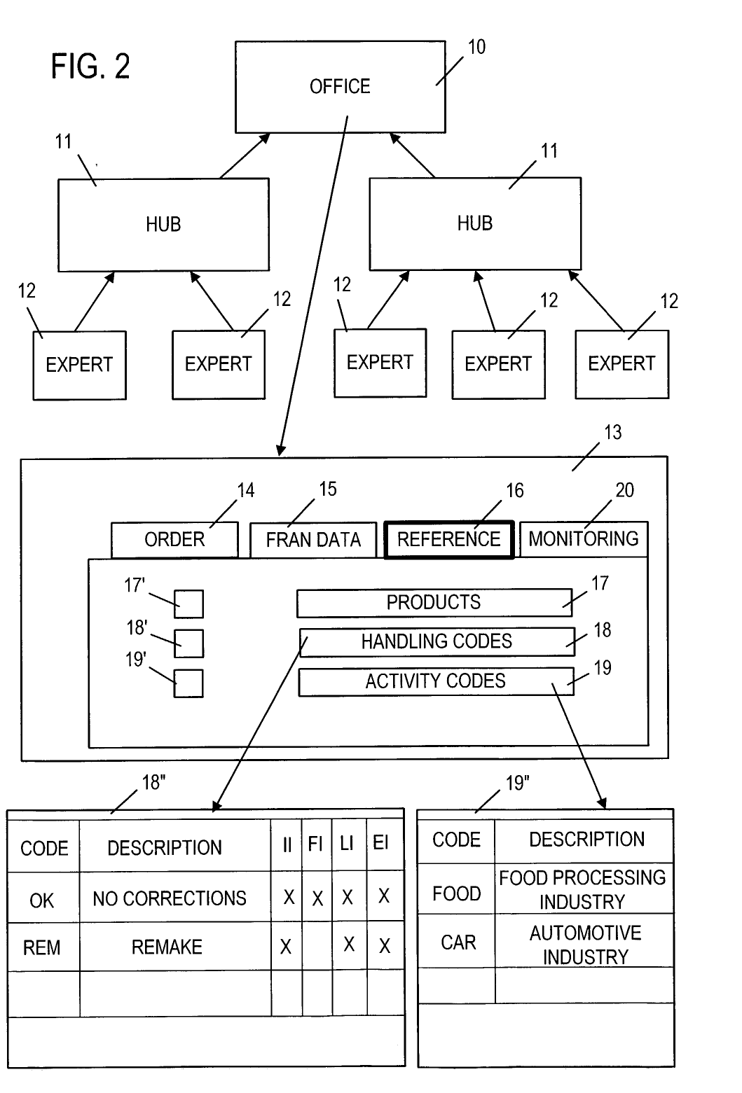

In FIG. 2 an illustrative detail is shown of the computer program implementing the system according to the invention.

### DETAILED DESCRIPTION

In the process flow illustrated in FIG. 1, the HCP-system 1, as described in correspondence with the method according to the invention is schematically categorised in three section: Record keeping 2, Activities 3 and Evaluation 4. With respect to record keeping 2, each step of HCP is recorded and stored in a database. The database is used as a management tool, from which reports can be drawn both on an individual level and on a group level, reporting a development of registration levels while possibly indicating extreme differences of measured (personal) noise levels, monitored effectiveness of PHP's or (individual) outcomes of the audiometric screening of employees. The HCP-database may be implemented on any computer platform. The computer comprises input means, such as a keyboard and/or a data-link with a noise level-detection unit, output means, such as a visual screen and/or a printer, processing means, such as a CPU and storing means, such as a magnetic or optical memory. The database is preferably organised as a relational database, stored in memory, wherein data grouped in records can be linked and indexed. Department 5, schematically illustrates that such records contain a job description of a respective employee and further personal data, the companies he or she works for and specifics of this company, such as name, address, correspondence address etc. Also, in the database the data is stored regarding the types of PHPs used. In a preferred embodiment custom molded hearing protectors equipped with a unique serial number (6 digits) and a tunable attenuation valve. By the serial number records on the PHP (type, test results, etc. . . . ) can be linked with the participant wearing them and stored in the database, establishing an actual and historical track record on the PHP Also, by opening or closing the valve one can set the attenuation with great accuracy in relation to the noise exposure level. Furthermore they offer the possibility to reset the attenuation when necessary (change of noise exposure level). In contrast, when pre-set (fixed) attenuation filters are being used one has to make a choice which type of filter comes as near as possible to what is recommended in the given situation (noise exposure level). This would lead to a situation where either a preset attenuation is too much or just not enough. Further, in department 6, an experienced noise level on the respective job floor of said employee; and a measured hearing capacity of said employee is stored. In department 7, a measured effectiveness of hearing protectors worn by said employee is input. The effectiveness is for instance measured in terms of comfort, leaktightness and attenuation. In a preferred embodiment the air-pressure method (ACS) is used to monitor the product liability (leaktight fit) when ‘in situ’ and also for installing and checking the attenuation of the PHP. The ACS is a device, developed to perform 2 tests:

1. Is it possible to build up a stable situation of overpressure (between 15-18 Pa) during 2 seconds? If so the ACS gives an OK for further testing.

2. Measure pressure-drop (airflow). The ACS converts pressure-drop into dB's of attenuation at 1 kHz.

The functionality of the (each) PHP greatly depends on its sealing effect of the ear canal while being worn. In order to test this, the custom molded PHP is (to be) provided with an open channel (1.5 mm to 3.5 mm) running through the body of the earpiece from the external part to the internal part. When the earpiece is ‘in situ’ a cavity is created between eardrum and hearing protector. By linking the tube of the ACS to the opening at the external part of the earpiece overpressure (15-18 Pa) can be created in this cavity. When the overpressure stays stable during 2 seconds, an objective proof of a ‘leaktight fit’ is delivered. Under normal working conditions (atmospheric pressure instead of overpressure) one can assume that the leaktight fit is absolutely guaranteed.

If this leaktight situation is not reached a fault code is generated and preventive/corrective measures are taken.

Outside the ear the level of attenuation of the filter/valve is monitored. When an attenuation filter/valve is mounted in (on) the channel running through the body of the earpiece and by linking the ACS to this channel, it measures the drop of pressure (airflow) through the opening of the filter/valve. The ACS converts this pressure drop into dB of attenuation at 1 KHz. When knowing the attenuation at 1 KHz of a said PHP and referring the technical datasheet of said attenuation filter/valve, we also know the attenuation at other frequencies of said PHP. Based on the information of the noise exposure level, based on the attenuation at 1 KHz of said PHP, one is in a position to reduce the noise exposure level under the safety limit while preserving to a maximum speech intelligibility and recognition of warning signals. In case pre-set (fixed) attenuation filters are being used one with the ACS only check whether the attenuation at 1 Khz of said filter corresponds with the technical specifications. When at 1 KHz a deviation is found, bigger than the allowed standard deviation of the fixed filter, there is a non-conformity of the product. In which case a faultcode is generated and preventive/corrective measures are to taken (returning filter to the manufacturer).

The data in the database, organised in this way, may be searchable using conventional querying techniques.

Referring further to the “Activities” section 3, this section indicates the activities performed by an audiometric expert in the HCP-system. These activities are schematically indicated by sections 8 and 9. Section 8 indicates the focus on screening of noise conditions on the work floor, comprising personal noise monitoring and audiometric screening on a regular basis (for instance: yearly). Section 9 focuses on the performance of PHPs, which is indicated by control characteristics such as: attenuation, leaktightness and comfort.

Further elaborating on the activities listed in section 8, the audiometric expert performs a measurement of noise levels. In doing so, in the preferred embodiment, a detection unit is coupled directly to the computer. The computer thus co-operates with a detection unit, which outputs detected noise levels that can be entered directly into the computer for further storing and processing. A preferred detection method is measuring the noise energy over time for a specific person or group of persons. In a preferred embodiment the method comprises to measure a persons individual noise energy over time using dose-badges. This way a persons noise-dose (time-averaged value) is obtained, which offers more reliable results as to simply measuring the noise energy at a specific place and time. Based on the outcome a selection is made of persons (participants) who are to be entered into the Risk Management System because their measured noise exposure level exceeds the safe limit set by the national law-and legislation. Secondly this information is of great value to install the attenuation of the personal hearing protector (PHP).

In this way a time-averaged value can be obtained, which offers more reliable results. The detection results, indicating noise levels (measured in dB(A)) are read out from the detection unit and stored in the database. Using a querying interface, the database may provide an overview of measured noise levels and hearing capacities of screened employees. Further, the measured noise levels and hearing capacities are related to an averaged value of functionally related employees or function groups in the database. The data collected in the central database serves as a reference for comparing the detection results with corresponding results found in other companies where a HCP system is implemented.

According to the inventive method, the screening of the hearing capacity is preferably performed by the Oto Acoustic Emission (OAE). In a further preferred embodiment the method comprises screening of the Oto Acoustic Emissions using ‘Simultaneous Distortion Product’—testing (DPOAE). In this respect, oto acoustic emissions are sounds created by active bio-mechanical processes within the outer cochlear hair cells of normal ears. Because overexposure to noise has a detrimental effect on cochlear hair cells, (leading to complete destruction in the long run), OAE screening is an objective method to detect early signs of overexposure to noise. Therefor, and specifically in the case of preventing occupational deafness, OAE screening has a ‘predictive’ character and is a very useful tool to evaluate the efficiency of the risk management system.

Therefor, such an OAE advantageously provides an objective screening method, independent of the individual, environment, and other external factors. Furthermore, this screening method is fast, cost-effective and very accurate. In case an employee appears to have insufficient hearing, the employee is referred for further testing to a medical department. An initial audiometric screening determines a baseline of the hearing capacity of each employee entering the HCP.

Preferably, in the HCP-system hearing protection is provided on an individual basis. By applying custom molded hearing protectors, an optimal response can be given to individual needs of each employee, specifically it is possible to install the attenuation to attenuate an individual noise exposure level. For instance, for people working in an environment with relatively low noise levels, a milder type of attenuation, for instance, specific attenuation (clipping) of sound level (amplitude) or also blocking only specific ranges of frequencies may be used, so that the person still has possibilities to use his hearing. For people working in conditions with relatively higher noise levels, a heavier type of attenuation is required. In this way, the employee is well protected while preserving optimal intelligibility to speech and recognition of warning signals. The PHPs are delivered with a possibility to perform objective tests on efficiency (leaktight fit and attenuation) when in place in the ear canal of a user.

The outcome of the test is conveyed immediately to an employee wearing the hearing protector, who is offered to sign for agreement. Also, employees must sign that they have been instructed in the proper use of the PHP and that they will wear his PHP when exposed to noise. In this way, commitment is obtained from the workers, and the occurrence of mistakes is minimized. The results of the screening of the hearing protectors are then validated for input in the database.

A key factor of the activities performed by the expert is the focus on MEET-sessions (motivation evaluation, education, and training), which are very relevant for implementing the HCP-system in a specific organisation. These sessions are structured vertically (group sessions for the management), as well as horizontally (MEET sessions on an individual basis for the workforce). On a group level, these MEET sessions are provided prior to implementing the HCP. Such MEET sessions have as a goal to obtain a broader understanding and acceptance of the people, workers and staff, who work with the HCP-system. For achieving this goal, the sessions comprise both educational elements (facts), motivational elements (arguments) and training (internalizing the HCP-strategy). The MEET-sessions teach staff and workers about the causes of occupational deafness, and how this can be prevented. MEET-sessions have as a goal to obtain a broader understanding, optimize the acceptance and collaboration and boost motivation to continue the long term policy.

A further element of HCP indicated in FIG. 1. is the “Evaluation” section 4. In an evaluation session, taking place regularly, for instance on an annual basis, the results of the noise survey (personal noise monitoring) and the results of the audiometric screening of the last year are presented and the development of experienced noise levels on the job floor is presented. Such an evaluation may have an interactive character, where people are able to react on the facts given and share their views. Obviously, while MEET-sessions prior to implementing the HCP are delivered to management and to employees, a regular undertaking of the activities results in an up to date monitoring and record keeping of the effect of these activities, and allows to re-adjust and to shift focus (for instance: from controlling the noise level to increasing the attenuation level of the PHP's) when necessary and to provide early warning signs when an employee is showing a reduced hearing capacity, so that a medical examination can be initiated. Further, repetition is a major contributing factor for obtaining better results from educating, motivating and training the employees.

An example of a database layout for organizing the results detected and measured in the HCP method is given with reference to FIG. 2. The database may be organised in subdatabases, in the example called “OFFICE” database 10, “HUB” database 11, and “EXPERT” database 12.

From an organizational point of view, the success of the HCP method greatly depends on the adequate organization. Therefor the system comprises: coupling means for synchronizing data between databases of the EXPERT/HUB/OFFICE. In such a layered system, the OFFICE database is in charge of several HUBS; a HUB is Managing (National or Regional) several experts; and the EXPERT database if for the (Local) Technician in the field performing the said activities. Each layer mirrors the lower level. This is organized such way that data input and storage at one level is (automatically) synchronized to the other level. This is organized in a top-to-bottom manner, OFFICE being the top and EXPERT being the bottom. Furthermore the data collected on two other levels serve as back-up in case of a break-down or calamity at one of the levels. For every company/participant entered in the ‘risk management system’ the annual ‘activities’ (to be performed by the experts) are planned automatically by the system.

In this respect, the sub databases are updatable and maintainable by a EXPERT, a “HUB” and an OFFICE administrator respectively. So, the data of the OFFICE database 10 is synchronized with the data collected in the HUB database 11; likewise, the data of the HUB database 11 is synchronized with the data collected in the EXPERT database 12. In this example, the database, wherein the actual data is input, is then the EXPERT database 12, whereas the HUB database 11 and the OFFICE database 10 serve as collector databases, collecting and centralizing the information of the EXPERT database 12. In such a synchronisation procedure all records of a database (the EXPERT database 12) which are new or modified are copied to a central database (indicated by arrowed lines). In this way, large collections of detection results can be accumulated. Meanwhile, the databases 10, 11 and 12 may be organised on different security levels, so that for instance a EXPERT is only allowed to enter information in the EXPERT database etc. The data collected in the central OFFICE database 10 may serve as a reference when detection results need to be compared with corresponding results found in other companies where a HCP system is implemented.

In the database a user interface 13 is provided which provides easy and swift access to information contained in that database (in FIG. 2, an illustration is shown of a user interface of the OFFICE database 10). On a first level, a history of orders, including new orders can be viewed or printed, via a tab “Orders” 14. This “Order” section 14 also provides a finance report for goods delivered. Also, a tab “EXPERT data” 15 is present, which provides access to a list of companies having adopted the HCP-system, the customers of said companies and the EXPERTs and experts which are assigned to these companies. Also, the EXPERTs are grouped and assigned to a HUB, which serves as a central reference between EXPERTs and the OFFICE. A tab “Reference” 16 provides a list of products 17 (personal hearing protectors), that are available, handling codes 18 related to these products, for handling corrections and/or errors and activity codes 19 , explained hereinafter. Still further, a tab “Monitoring” 20 provides a schedule of companies and persons to be monitored, and the hearing protectors they use.

“Reference” tab 16 is printed in bold lines, indicating that this tab is currently active in user interface 13. When active, a list of products 17, handling codes 18 and activity codes 19 are accessible via corresponding buttons 17′, 18′ and 19′. An example of handling codes is given in section 18″. Such handling codes may be code “OK”, for indicating a perfectly functioning product, code “REM” for deleting and remaking the product, or other types of corrections like applying a new coating layer. The handling codes may be grouped in different stages of inspection, for instance stage “II” (initial inspection), “FI” (fitting inspection), “LI” (leaktightness inspection) and “EI” (end inspection). It will be clear, that only products that obtained mark “OK” in all stages of inspection will be finally approved. The handling codes are helping to create an insight of the quality of specific types of products in relation with the job floors on which they are used and to identify specific quality problems in relation with certain products, such as for instance, a specific type of hearing protector which suffers from a higher rate of leaking than other types of hearing protectors.

Also a list of “activity codes” 19″ is provided, which can be designed to fit a group of companies served by the HCP-database. Such activity codes are assigned to companies served by the HCP-system according to the activities they undertake, for instance code “Food” for food processing industry, code “Car” for automotive industry etc. These codes can be used to identify references for comparing the specific data of the HCP-system in relation to a company where it is implemented, with corresponding results found in other companies where the HCP system is implemented.

In elaboration on the above mentioned section “Orders”, if for instance an EXPERT has paid a visit to a company, like an automobile company, the EXPERT will have input new data that are updated to the OFFICE data. The new data are related to the employers and the hearing protectors that are screened. Usually, from such a screening, a list of hearing protectors is obtained, that have faulty handling codes. Thus, by inspecting the Orders list, one can derive the specific types and numbers of hearing devices that need to be corrected or replaced.

From the above it will be understood that the HCP-database, organised in an OFFICE database, a HUB database and a EXPERT database, contains personalia and records of individual employees of companies served by the HCP-system. The records contain data on individual noise exposure levels (initial and subsequent); audiometric screening results (initial and subsequent), type of hearing protectors; test results on the hearing protector (fit, leaktightness, attenuation (initial and subseqent) and the employee's personal appraisal on the PHP: comfort wearing frequency and instruction level. While filling in, a consistency check can be performed on the input data, assessing the completeness and correctness thereof.

Through querying, a list may be provided from the database of employees in need of improved hearing protection. This is for instance the case when, in the above described example, at least some of the handling codes of a PHP used by a specific employee, in the screening process, appear to have a faulty status. Also from the HCP-database, a list can be provided of employees having a hearing capacity that did not pass the audiometric screening, as well as an overview hearing capacities grouped for instance by function types present in a company or by companies activity codes.

It will be clear to those skilled in the art that the invention is not limited to the embodiment described with reference to the drawing but may comprise all kinds of variations thereof. Such variations are deemed to fall within the scope of protection of the appended claims.

1. Method for monitoring, evaluating and improving the conditions for employees of a business with a noisy environment, wherein the method comprises:
a) creating records in a computer database, the records representing employees, and receiving and storing in said respective records of said database the information of:
i) a job function of a respective employee;
ii) an experienced noise level on the respective job floor of said employee;
iii) a measured effectiveness of hearing protectors worn by said employee;
iv) a measured hearing capacity of said employee;
b) providing a list of employees in need of improved hearing protection having an experienced noise level that is higher than a pre-selected value or wearing a hearing protector with an effectiveness that is lower than a pre-selected value;
c) providing a list of employees having a hearing capacity that is less than a pre-selected value; and
d) providing an overview of measured noise levels and hearing capacities of screened employees.

2. Method according to claim 1, further comprising the step of receiving and storing in a respective database record a code identifying the possibility for said employee to wear hearing protectors in view of hazards with respect to warning signals or speech-intelligibility.

3. Method according to any of the preceding claims, wherein the step of receiving and storing information regarding a measured noise level comprises a read out from a detection unit which can be coupled directly to the computer.

4. Method according to claim 3, wherein the detection unit measures the noise energy over time for a specific person or group of persons.

5. Method according to any of the preceding claims, wherein the step of measuring a hearing capacity comprises applying an Oto Acoustic Emission (OAE), such measurement resulting in a PASS or a REFER outcome.

6. Method according to any of the preceding claims, wherein the step of receiving and storing information regarding a measured effectiveness of a hearing protector comprises information regarding the wearing frequency, attenuation, leaktightness and experienced comfort.

7. Method according to claim 6, further comprising receiving information that said employee agrees with of the measured effectiveness.

8. Method according to any of the preceding claims, wherein providing said overview comprises relating measured noise levels and hearing capacities to an averaged value of functionally related employees or function groups in the database.

9. Computer for monitoring, evaluating and improving the conditions for employees of a business with a noisy environment, comprising:
a) storing means for storing entities comprising information of:
i) an employee;
ii) a job function of said employee;
iii) an experienced noise level on the respective job floor of said employee;
iv) a measured effectiveness of hearing protectors worn by said employee;
v) a measured hearing capacity of said employee;
b) input means for inputting said information in said storing means
c) processing means coupled to said storing means for determining entities with an experienced noise level that is higher than a pre-selected value or wearing a hearing protector with an effectiveness that is lower than a pre-selected value and for determining entities with a hearing capacity that is less than a pre-selected value;
d) processing means coupled to said storing means for determining an averaged value of measured noise levels and hearing capacities of a selected group of entities
e) output means for conveying a list of employees in need of improved hearing protection, for conveying a list of employees having a reduced hearing capacity and for providing an overview of measured noise levels and hearing capacities of screened employees, determined by the processing means.

10. Computer according to claim 9, wherein the input means comprises coupling means for inputting a detected noise level of a noise level detection unit.

11. Computer according to claims 9-10, wherein the computer comprises coupling means for coupling to a central computer storing a history of inputted entities of the database.

12. Computer program product that is machine readable to a computer for monitoring, evaluating and improving the conditions for employees of a business with a noisy environment, wherein, after the computer program product is read, the computer is configured according at least one of claims 9-11.

13. Information carrier comprising a computer program product according to claim 12.
